(19) United States
(12) Patent Application Publication
(10) Pub. No.: US 2025/0309585 A1
(43) Pub. Date: Oct. 2, 2025

(54) COMPACT HIGH-CURRENT CONNECTOR

(71) Applicant: FCI CONNECTORS DONGGUAN LTD., Dongguan (CN)

(72) Inventors: Hongbing Liu, Dongguan (CN); Peiming Zheng, Dongguan (CN); Shixiang Lu, Dongguan (CN)

(73) Assignee: FCI CONNECTORS DONGGUAN LTD., Dongguan (CN)

(21) Appl. No.: 19/087,418

(22) Filed: Mar. 21, 2025

(30) Foreign Application Priority Data
Mar. 27, 2024 (CN) 202420602420.6

(51) Int. Cl. H01R 13/627; H01R 12/77; H01R 13/04; H01R 13/506

(52) U.S. Cl. CPC H01R 13/6272; H01R 12/77; H01R 13/04; H01R 13/506

(57) ABSTRACT

Compact high-current connector. The connector includes a housing, and first and second terminals held by the housing. Each terminal includes multiple terminal members. Each terminal member includes a planar portion and a tab coupled to the planar portion. First and second cables are attached to respective terminal members of the first terminal. Third and fourth cables are attached to respective terminal members of the second terminal. The housing includes a first portion with a mating end having first and second slots, and a second portion attached to one or more sides of the first portion and configured to at least partially enclose cable attachments. Terminal position assurance (TPA) devices are disposed on the first portion and extend into the slots so as to restrain movements of terminal members of each terminal. Such a configuration enables a compact connector with terminals having a current carrying capacity up to 140 A/terminal.

### CROSS REFERENCE TO RELATED APPLICATION

This application claims priority to and the benefit of Chinese Patent Application No. 202420602420.6 filed on Mar. 27, 2024, which is incorporated by reference herein in its entirety.

### TECHNICAL FIELD

This application relates to interconnection systems, such as those including electrical connectors, configured to interconnect electronic assemblies.

### BACKGROUND

Electrical connectors used to transmit data signals and/or electrical power, such as alternating current (AC) power and/or direct current (DC) power, may include a plurality of power contacts and a plurality of signal contacts mounted in an electrically-insulative housing. In a typical application, the connector may be configured to be mounted onto a printed circuit board, such as a printed circuit board, and configured to mate with a complementary electrical component, which can be a power cable or complementary electrical connector, for example. Specifically, each contact within the housing may include one or more header and/or receptacle contacts that mate with opposed receptacle and/or header contacts, respectively, of the complementary electrical component.

### SUMMARY

Aspects of the present disclosure relate to compact high-current connectors.

Some embodiments relate to an electrical connector. The electrical connector may comprise a housing comprising a first portion having a mating end having first and second slots, and a second portion attached to one or more sides of the first portion; first and second terminals, each of the first and second terminals comprising a plurality of terminal members, each of the plurality of terminal members comprising a mating end disposed in a respective slot of the first and second slots of the first portion of the housing and a tail at least partially disposed in the second portion of the housing; and a plurality of cables attached to respective terminal members of the first and second terminals and extending out of the housing through a side of the second portion of the housing.

Optionally, the electrical connector further comprises first and second terminal position assurance (TPA) devices disposed on the first portion of the housing, the first and second TPA devices configured to restrain movements of the plurality of terminal members in the first and second slots, respectively.

Optionally, each of the first and second TPA devices comprises a body configured for engaging the plurality of terminal members of a respective terminal of the first and second terminals, and a latch extending from the body and configured for engaging the housing.

Optionally, each of the first and second terminals comprises first and second terminal members, each of the first and second terminal members comprising a planar portion extending from the mating end to the tail, and a tab extending from the tail of the planar portion and attached to a respective cable of the plurality of cables.

Optionally, the first portion of the housing comprises a front plate, and one or more posts protruding from the front plate toward the mating end.

Optionally, the housing comprises a third portion protruding from the first portion and configured to receive a connector position assurance (CPA) device.

Optionally, the first portion of the housing comprises a plurality of apertures disposed between the first and second slots.

Some embodiments relate to a cable assembly. The cable assembly may include a terminal comprising first and second terminal members, the first terminal member comprising a first planar portion extending in a first plane and a first tab coupled to the first planar portion and extending in a second plane perpendicular to the first plane, the second terminal member comprising a second planar portion extending in a third plane parallel to the first plane and a second tab coupled to the second planar portion and extending in a fourth plane parallel to the second plane; and first and second cables, each of the first and second cables comprising an insulation and a wire disposed in the insulation and having an end extending beyond the insulation, the end of the wires of the first and second cables welded to the first and second tabs, respectively.

Optionally, each of the first and second planar portions comprises first and second edges opposite to each other, and first and second broadsides opposite to each other and both joining the first and second edges; the first tab is coupled to the first edge of the first planar portion of the first terminal member; and the second tab is coupled to the second edge of the second planar portion of the second terminal member.

Optionally, both the first tab and the second tab extend away from either the first broadsides or the second broadsides of the first and second planar portions.

Optionally, the end of the wires of the first and second cables are welded to the first and second tabs at their sides; and front surfaces of the wires of the first and second cables are welded to the first planar portion.

Optionally, the terminal is a first terminal; and the cable assembly comprises: a second terminal comprising third and fourth terminal members, the third terminal member comprising a third planar portion extending in a fifth plane parallel to the first plane and a third tab coupled to the third planar portion and extending in a sixth plane parallel to the second plane, the fourth terminal member comprising a fourth planar portion extending in a seventh plane parallel to the first plane and a fourth tab coupled to the fourth planar portion and extending in an eighth plane parallel to the second plane; and third and fourth cables, each of the third and fourth cables comprising an insulation and a wire disposed in the insulation and having an end extending beyond the insulation, the end of the wires of the third and fourth cables welded to the third and fourth tabs, respectively.

Optionally, each of the third and fourth planar portions comprises first and second edges opposite to each other, and first and second broadsides opposite to each other and both joining the first and second edges; the third tab is coupled to the first edge of the third planar portion of the third terminal member; and the fourth tab is coupled to the second edge of the fourth planar portion of the fourth terminal member.

Optionally, both the third tab and the fourth tab extend away from either the first broadsides or the second broadsides of the third and fourth planar portions.

Optionally, the end of the wires of the third and fourth cables are welded to the third and fourth tabs at their sides; and front surfaces of the wires of the third and fourth cables are welded to the third planar portion.

Optionally, the cable assembly comprises a housing comprising first and second slots configured to receive complementary terminals for mating with the first and second terminals, respectively.

Optionally, the cable assembly comprises first and second terminal position assurance (TPA) devices disposed on the housing and configured to restrain movements of the first and second terminals, respectively.

Optionally, each of the first and second TPA devices comprises a body configured for engaging a respective terminal of the first and second terminals, and a latch extending from the body and configured for engaging the housing.

Some embodiments relate to an electrical connector. The electrical connector may comprise a housing; first and second terminals held by the housing, each of the first and second terminals comprising two terminal members, each of the two terminal members comprising a planar portion and a tab coupled to the planar portion; first and second cables attached to respective terminal members of the two terminal members of the first terminal; and third and fourth cables attached to respective terminal members of the two terminal members of the second terminal, wherein each of the first and second terminals has a current carrying capacity up to 140 A/terminal.

Optionally, the housing comprises a first portion having one or more posts protruding in a mating direction, and a second portion attached to one or more sides of the first portion.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of an electrical connector, according to some embodiments, looking from a left side of a mating interface, showing a connector position assurance (CPA) device and a terminal position assurance (TPA) device separated from a housing.

FIG. 2 is a top, front perspective view of the connector of FIG. 1, with an alternative cover, according to some embodiments, looking from a right side of the mating interface.

FIG. 3 is a bottom, front perspective view of the connector of FIG. 2, looking from the right side of the mating interface.

FIG. 4A is a rear, bottom perspective view of the connector of FIG. 1, looking from the left side of the mating interface, with a cover separated from the body portion.

FIG. 4B is a perspective view of the connector of FIG. 4A, with components hidden and showing terminal members of one terminal, cables attached thereon and a terminal position assurance (TPA) device configured to restrain movements of the terminal.

FIG. 5 is a cross-sectional view of a portion of the connector of FIG. 1 along a line marked “5” in FIG. 1.

### DETAILED DESCRIPTION

The inventors have recognized and appreciated connector design techniques that enable compact, high-current connectors. The connectors may be mounted within a chassis for connection to a power supply. Conventional connectors often use a large number of pins (e.g., six or more), each typically crimped to a cable. Due to their configuration, each pin may have relatively small current capacity (e.g., 50A/terminal). As a result, such conventional connectors tend to be relatively large, both because of the number of pins and the spacing required between them. Techniques described herein may enable connectors that are more compact in size while offering higher current capacity (e.g., 140 A/terminal).

According to aspects of the present disclosure, a connector may include a housing, and first and second terminals held by the housing. Each terminal may include multiple terminal members. Each terminal member may include a planar portion and a tab coupled to the planar portion. The planar portion and the tab may extend in planes that are substantially perpendicular to each other. The tabs may be bent either left or right relative to the plane of the planar portion, such that the connector may be configured as a left or right outlet, depending on the requirements of a system in which the connector is used.

In some embodiments, the planar portion of each terminal member may include first and second edges opposite to each other, and first and second broadsides opposite to each other and both joining the first and second edges. The tabs of each terminal may be bent from opposite edges of respective terminal members.

In some embodiments, first and second cables may be attached to respective terminal members of the first terminal. Third and fourth cables may be attached to respective terminal members of the second terminal. Each cable may include an insulation and a wire disposed in the insulation and having an end extending beyond the insulation. The wire of each cable may be attached to the tab of a respective terminal member, for example, by ultrasonic welding. The wires of the first and second cables may have a front surface attached to one of the terminal members of the first terminal, for example, by ultrasonic welding. The wires of the third and fourth cables may have a front surface welded to one of the terminal members of the second terminal, for example, by ultrasonic welding.

In some embodiments, the housing may include a first portion with a mating end having first and second slots, and a second portion attached to one or more sides of the first portion and configured to at least partially enclose cable attachments. In some embodiments, the second portion may be connected to the first portion through a dovetail groove and multiple buckles, securing the second portion to the first portion to reduce the risk of detachment while still allowing for easy disassembly to access cable attachments.

In some embodiments, terminal position assurance (TPA) devices may be disposed on the first portion of the housing and extend into the slots so as to restrain movements of terminal members of each terminal. For example, a TPA device may include a body configured for engaging a respective terminal of the first and second terminals, and a latch extending from the body and configured for engaging the housing.

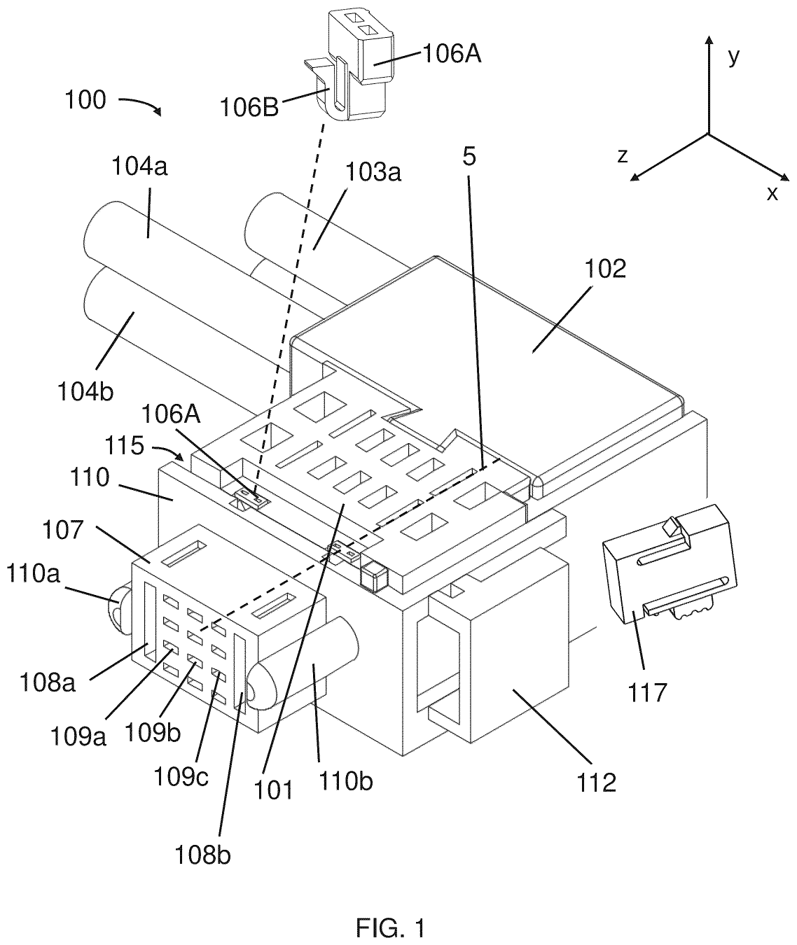

Referring to FIGS. 1-5, a connector 100 may include a body portion 101, a cover 102 arranged on the body portion 101, terminals 105 extending from a front to a rear, a first cable 103a connected to a first terminal 105 at the rear side, and a second cable 104a connected to a second terminal 105 at the rear side. The first cable 103a and the second cable 104b may extend in parallel to each other. The first cable 103a and the second cable 104b may include wires electrically connected to the terminals 105. The connector 100 may include a TPA 106 disposed at a side of the inner cavity of the body portion 101. The TPA 106 may be configured to restrain movements of the terminals 105.

In some embodiments, the body portion 101 is made of plastic, and the cover 102 closes three sides of the body portion 101. The cover 102 may reduce the risk of dust entering the inner cavity of the body portion 101.

In some embodiments, the cover 102 and the body portion 101 are connected through dovetail grooves and a plurality of buckles. The dovetail grooves and the plurality of buckles provide anti-detachment and easy disassembly to cover 102 and also fix the positions of first cable 103a and second cable 104a.

In some embodiments, the material thickness of a terminal 105 is 0.70 mm. The terminal may have a planar portion 404 and a side tab 406, and the terminal may be attached to a respective one of first cable 103a and second cable 104a at one or more of the planar portion 404 and side tab 406 by, for example, ultrasonic welding process. The ultrasonic welding process avoids the limitation of current carrying capacity caused by crimping process. Accordingly, the stability and current carrying capacity are greatly improved, and the reliability of the connection between terminal 105 and the cables is improved.

Each terminal 105 may include two members disposed side by side. A first cable 103a and a third cable 103b can be welded to respective members of the terminal 105 to enhance the current carrying capacity of the connector.

When in use, the connector provides improved current carrying capacity when compared with similar cable-to-board schemes of traditional connectors which operate with a current of about 50 A/terminal current. By contrast, the current carrying capacity of the present connector can reach 140 A/terminal.

Additionally, by bending terminal 105 in different directions, the outgoing cables on both the left and right sides can adapt to a wider range of application scenarios. When combined with the bent terminal, multiple partitions help prevent short circuits, increase creepage distance, and enhance electrical clearance, enabling high-voltage (2500 V) applications. This design also supports a high working voltage of 1570 V, ensuring safety in ultra-high voltage environments.

In some embodiments, the cover includes a dovetail groove and multiple buckles to secure the first cable 103a and second wiring harnesses 104a while preventing the cover 102 from detaching from the body portion 101. The dovetail groove and multiple buckles secure the cover from detachment along all directions.

With reference to the individual figures, FIG. 1 shows an assembled connector 100 in a first perspective view. Connector 100 includes body portion 101 and cover 102. Body portion 101 includes a front plate 110 and a mating housing portion 107 extending from front plate 110. The mating housing portion 107 includes a mating interface which includes slots through which terminal members are received when mating the electrical connector. A first slot 108a and a second slot 108b are disposed at the mating interface of mating housing portion 107.

The first 108a and second 108b slots are spaced apart along the x-axis (which may refer to a height direction of connector 100). Multiple apertures are included between the first and second slots at the mating interface. For example, apertures 109a, 109b, and 109c are included in the mating interface and disposed between first slot 108a and second slot 108b.

The first 108a and second 108b slots are elongated along the y-axis (which may refer to a width direction of connector 100), the y-axis being perpendicular to the x-axis. The elongation and shape being configured to receive terminal members into the slots 108a and 108b for mating with terminals 105.

Mating posts 110a and 110b are included for guiding the housing during mating to prevent damage to the terminals and corresponding terminal members. Mating posts 110a and 110b are disposed adjacent to the mating housing portion. As shown in FIG. 1, the mating posts are spaced apart along the x-axis such that the mating posts are disposed adjacent to the first 108a and second 108b slots and also being spaced apart from slots 108a and 108b along the x-axis.

Body portion 101 may include a CPA housing portion 112 that extends from the body portion 101 along the x-axis and forms a cavity between the walls of the CPA housing portion and the body portion 101. The CPA housing portion is configured to support the movement of a connector position assurance (CPA) device 117 along the z-axis (which may refer to a mating direction of connector 100) through the housing. The CPA device may be configured to secure the connecter 100 to a complementary connector when mated with the complementary connector.

As shown in FIG. 1, the CPA housing portion 112 is attached to body portion 101 on the top and bottom sides of the CPA housing portion, where the sides are separated from one another along the y-axis.

The connector includes multiple cables. In the illustrated example, the cables extend perpendicular to the mating direction of the connector. The connector is configured to mate along the z-axis, while the cables 103a, 103b, 104a, and 104b extend along the x-axis.

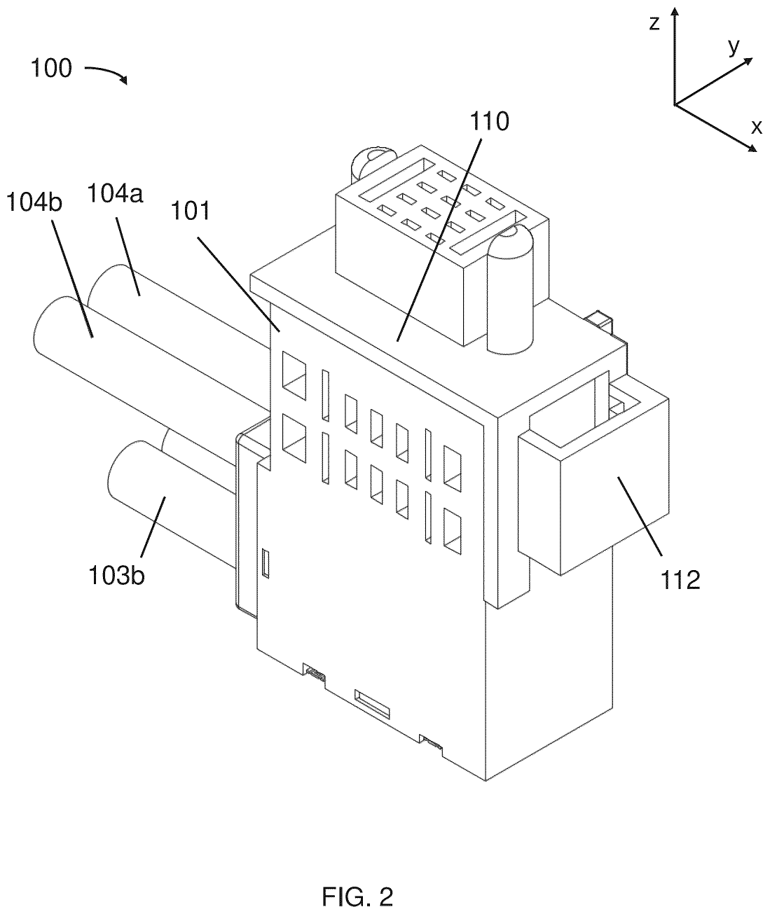

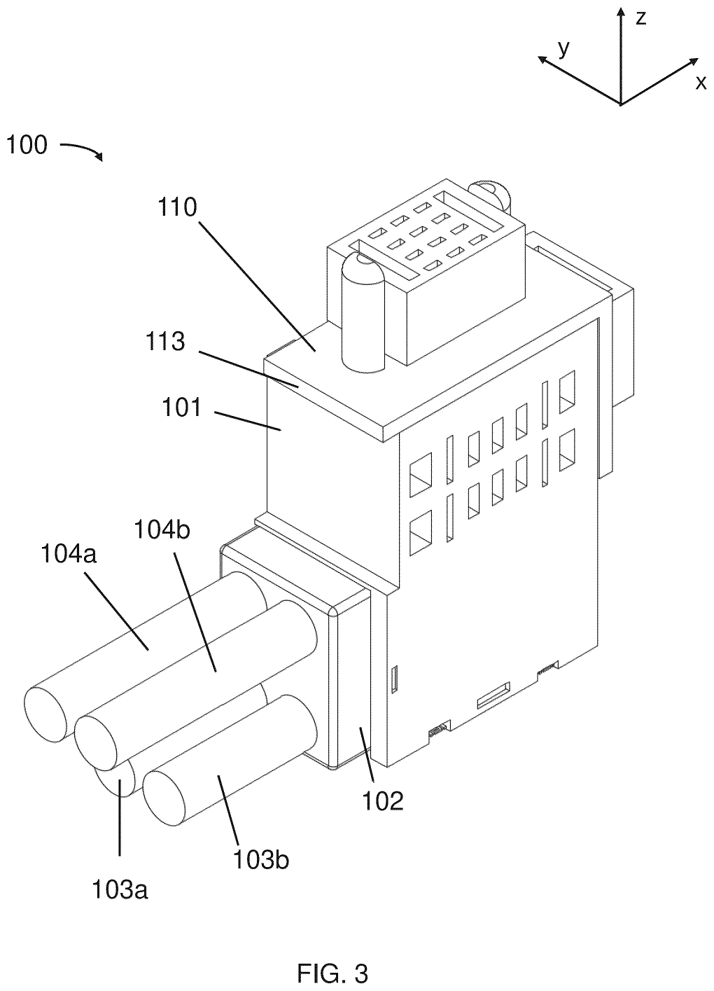

FIG. 2 and FIG. 3 each show a different perspective view of example connector 100, with an alternative cover 102. FIG. 2 shows a rotated view of body portion 100. In the rotated view, the CPA housing portion 112 is shown on the opposite side of the body portion as the cables 103 and 104 which extend away from the back of the body portion. Accordingly, the CPA housing portion and the corresponding CPA device remain accessible when the connector is assembled, with the cables extending in an opposite direction such as to not interfere with the operation of the CPA device.

The bottom surface of body portion 101 includes channels through which the cover may attach. The channels may be configured to receive latching components form the cover and may otherwise include a flat surface. The flat bottom surface of body portion 101 may also include additional apertures through the flat surface, as shown in FIG. 2.

In some embodiments, body portion 101 may include a retention portion. As shown in FIG. 1, in some embodiments, a groove 115 may be formed between the front plate 110 and another portion of the body portion 101. As shown in FIGS. 2-3, the front plate 110 may include extension113 that extends past the side wall of body portion 101. In some embodiments, when the connector is mated and the locking portion is extended, the retention portion prevents the connector from being detached. The extension 113 and the body portion 101 are configured such that a cavity is formed adjacent to body portion 101 between extension 113 and the cables 103 and 104 that extend from cover 102. When mated, a retaining wall from the mating interface mates with the cavity behind extension 113 and adjacent to body portion 101. Accordingly, the retaining wall abuts the back of extension 113 and restrains movement of connector 100 along the z-axis. In some embodiments, connector 100 may be disposed inside a chassis of an electronic device. Front plate 110 may be disposed outside an opening in a panel of the chassis. In some embodiments, a portion of the panel of the chassis may be disposed in groove 115 such that connector 110 is retained to the panel of the chassis. In some embodiments, extension 113 may extend outward the opening so as to abut the panel of the chassis, thereby retaining connector 110 to the panel of the chassis.

The connector is configured to mate in a mating direction. As an example, the connector may be inserted along the z-axis into a mating interface. Once mated, the connector may be moved along the x-axis such that a retaining wall from the mating interface slides into the cavity behind extension 113. Once the retaining wall is in place, the retaining wall resists movement of the connector along the z-axis.

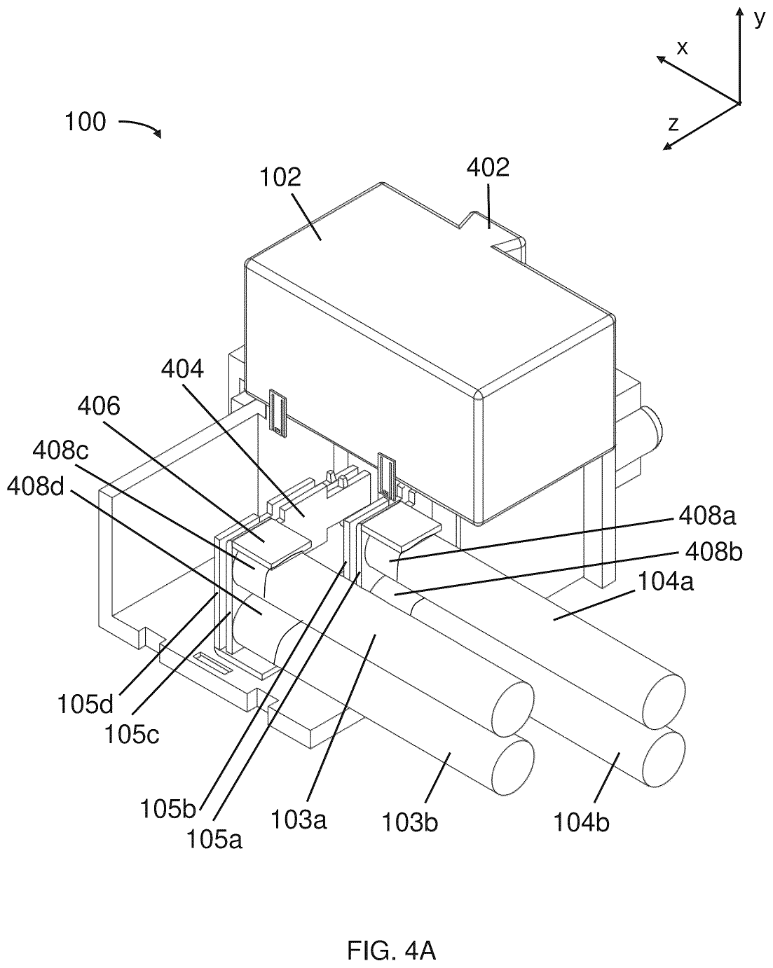

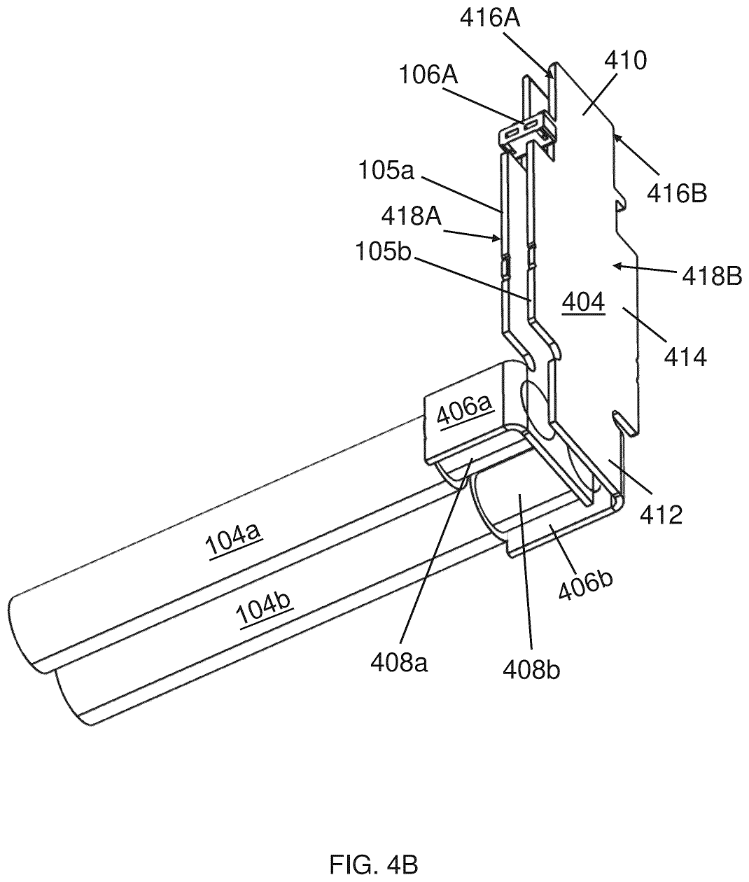

As shown in FIG. 4A, the body portion includes a cavity for accommodating the terminals 105. The mounting interface of the terminals is shown in FIGS. 4A-4B within the cavity of the body portion. The terminals are arranged in pairs that extend along the z-axis from the mating interface to the mounting interface. When mated, terminals inserted through the front plate of the connector slide between the pairs of terminals to conductively couple to the terminals.

In the example of FIGS. 4A-4B, each terminal is coupled to two cables at the mounting interface. The cables 103a and 103b mount to a terminals 105 and the cables 104a and 104b mount to a second terminal. The terminals may be different lengths such that the mounting interfaces are offset in the z-axis. By offsetting the mounting interfaces, the cables 103a and 103b may be positioned adjacent to cables 104a and 104b such that the cables mounted to one of terminal do not obscure the mounting interface of the other terminal.

To encapsulate the mounting interface, cover 102 is configured to engage the body portion and close the cavity of the body portion from the surrounding environment. In addition to the dovetail protrusion for mating, the cover 102 includes buckles 120 and 122 for mating cover 102 with body portion 101. Accordingly, body portion 101 includes grooves 121 and 123 configured to mate with buckles 120 and 122, respectively.

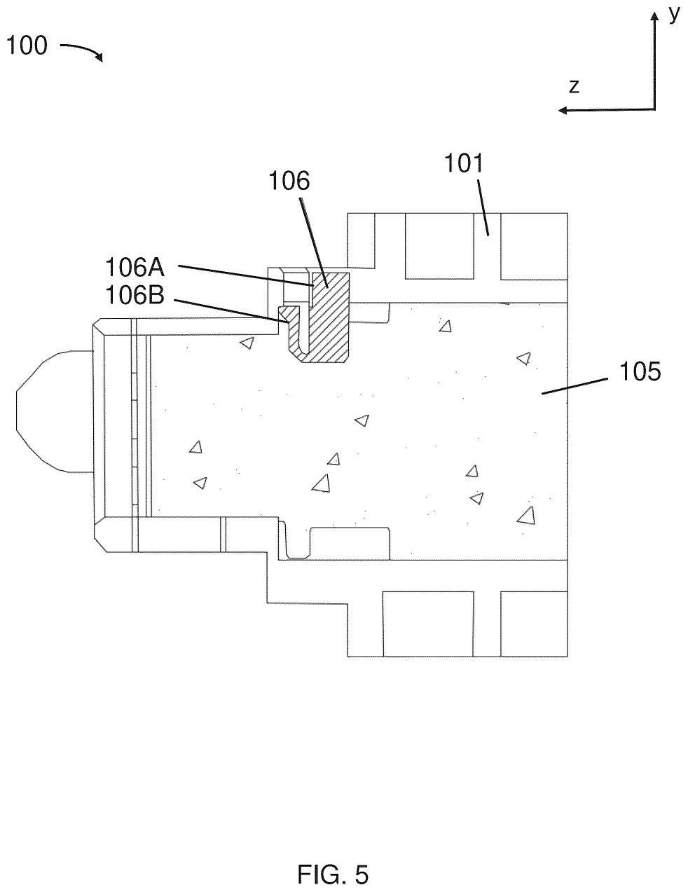

FIG. 5 shows a cross-sectional view along the yz-plane through connector 100. As shown in FIG. 5, terminal 105 is disposed inside body portion 101. Accordingly, the terminal 105 is retained in body portion 101. The terminal 105 may abut plastic protrusions of the body portion.

To retain terminals 105 in position, TPA 106 may be inserted through body portion 101 to restrain movements of terminals 105 and prevent them from withdrawing from body portion 101. TPA 106 may include a body 106A configured for engaging the terminals 105 and a latch 106B configured for engaging the housing. It should be appreciated that terminal 106 and the latch 106B may offset from each other in the x-axis direction.

The terminal may include a notch, into which the TPA may be inserted when securing terminal 105 in place. TPA 106 may be inserted through body portion 101 into the corresponding notch on terminal 105. TPA 106 may restrain the movement of terminal 105 and provide safe and reliable retention of the terminal 105. As shown in FIG. 5, the latch 106B may prevent TPA 106 from falling off from body portion 101. When inserted, forces on the latch 106B may cause it to compress, changing the width of TPA 106. Once inserted past the entry point of body portion 101, the cavity provides space for the latch 106B to expand away from the body of the TPA. Once expanded, the top of the latch 106B incudes a flat side for abutting the surface of the housing. Accordingly, the flat side of the latch 106B may prevent the TPA from sliding back out through the housing.

The presence of the TPA in the cavity restricts the movement of the terminal out of the housing. For example, when terminal 105 experiences forces along the z axis, the terminal motion is restricted by TPA 106. Thus, tension applied to the cables extending out the back of the terminal will exert force along the z-direction. The TPA will resist the movement of the terminal in response to such tension along the z-direction. Similarly, force generated along the z-axis while mating will be resisted by the TPA to aid in maintaining the position of the terminal.

As illustrated, the terminal may have a planar portion 404. The planar portion 404 provides a broad surface for mating with corresponding mating terminals which may be received through the front of the connector. The positioning of the terminals provides a broad contact area during mating which may facilitate low resistance current transfer.

Various aspects are described in this disclosure, which include, but are not limited to, the following aspects:

1. An electrical connector, comprising: a first insulative housing portion (e.g., 101) comprising a plurality of receptacles (e.g., 108a, 108b) disposed in a mating surface of a front plate (e.g., 110) of the first insulative housing portion at a mating end of the electrical connector, the first insulative housing portion further comprising a rear end at an opposing side of the electrical connector to the mating end, and wherein the plurality of receptacles comprises: a first receptacle and a second receptacle spaced apart from the first receptacle, wherein the first receptable and the second receptacle each comprise slots; a plurality of posts (e.g., 110a, 110b) disposed at the mating surface, the plurality of posts comprising a first post and a second post, the first post and the second post disposed on opposing sides of the plurality of receptacles; a second insulative housing portion (e.g., 102) configured to close one or more sides of the first insulative housing portion, wherein the second insulative housing portion comprises one or more protrusions (e.g., 402) configured to engage one or more complementary recesses of the first insulative housing portion; a plurality of terminal members (e.g., 105a, 105b, 105c, 105d), wherein each terminal member of the plurality of terminal members comprises a planar portion (e.g., 404) extending from the mating end to the rear end; a plurality of cables (e.g., 103a, 103b, 104a, 104b) ultrasonically attached to a mounting interface of the plurality of terminal members, wherein insulation of the plurality of cables is mechanically coupled to the second insulative housing portion; and a third insulative housing portion (e.g., 112) protruding from the first insulative housing portion and configured to receive a CPA device.

2. The electrical connector of aspect 1, wherein each terminal member of the plurality of terminal members comprises a notch in the planar portion configured to abut a TPA.

3. The electrical connector of aspect 2, wherein the notch is elongated.

4. The electrical connector of aspect 1, wherein the mating surface extends from the front plate of first insulative housing portion.

5. The electrical connector of aspect 4, wherein the first post and the second post each extend further from the front plate of first insulative housing portion than the mating surface.

6. The electrical connector of aspect 1, wherein the front plate comprises a plurality of apertures disposed between the plurality of receptacles.

7. The electrical connector of aspect 1, wherein the third insulative housing portion comprises a groove to receive a protrusion from the CPA device.

8. The electrical connector of aspect 1, further comprising the CPA device disposed in the third insulative housing and configured to extend at least to the front plate of first insulative housing portion.

9. The electrical connector of aspect 1, wherein the plurality of terminal members comprise: a first terminal member (e.g., 105a) disposed in the first receptacle and electrically coupled to a first wire (e.g., 408a) at a mounting interface; a second terminal member (e.g., 105b) disposed in the first receptacle and electrically coupled to a second wire (e.g., 408b) at the mounting interface; a third terminal member (e.g., 105c) disposed in the second receptacle and electrically coupled to a third wire (e.g., 408c) at the mounting interface; and a fourth terminal member (e.g., 105d) disposed in the second receptacle and electrically coupled to a fourth wire (e.g., 408c) at the mounting interface.

10. The electrical connector of aspect 9, wherein the first terminal member and the second terminal member are electrically coupled, and wherein the third terminal member and the fourth terminal member are electrically coupled.

11. An electrical connector, comprising: a housing comprising a first portion (e.g., 101) having a mating end having first and second slots (e.g., 108a, 108b), and a second portion (e.g., 102) attached to one or more sides of the first portion; first and second terminals (e.g., 105), each of the first and second terminals comprising a plurality of terminal members (e.g., 105a, 105b, 105c, 105d), each of the plurality of terminal members comprising a mating end (e.g., 410) disposed in a respective slot of the first and second slots of the first portion of the housing and a tail (e.g., 412) at least partially disposed in the second portion of the housing; and a plurality of cables (e.g., 104a, 104b, 104c, 104d) attached to respective terminal members of the first and second terminals and extending out of the housing through a side of the second portion of the housing.

12. The electrical connector of aspect 11, further comprising: first and second terminal position assurance (TPA) devices (e.g., 106) disposed on the first portion of the housing, the first and second TPA devices configured to restrain movements of the plurality of terminal members in the first and second slots, respectively.

13. The electrical connector of aspect 12, wherein each of the first and second TPA devices comprises a body (e.g., 106A) configured for engaging the plurality of terminal members of a respective terminal of the first and second terminals, and a latch (e.g., 106B) extending from the body and configured for engaging the housing.

14. The electrical connector of aspect 11, wherein each of the first and second terminals comprises first and second terminal members, each of the first and second terminal members comprising a planar portion (e.g., 404) extending from the mating end to the tail, and a tab extending from the tail of the planar portion and attached to a respective cable of the plurality of cables.

15. The electrical connector of aspect 11, wherein the first portion of the housing comprises a front plate (e.g., 110), and one or more posts (e.g., 110a, 110b) protruding from the front plate toward the mating end.

16. The electrical connector of aspect 11, wherein the housing comprises a third portion (e.g., 112) protruding from the first portion and configured to receive a connector position assurance (CPA) device (e.g., 117).

17. The electrical connector of aspect 11, wherein the first portion of the housing comprises a plurality of apertures (e.g., 109a, 109b, 109c) disposed between the first and second slots.

18. A cable assembly comprising: a terminal (e.g., 105) comprising first and second terminal members (e.g., 105a, 105b), the first terminal member comprising a first planar portion (e.g., 404) extending in a first plane and a first tab (e.g., 406a) coupled to the first planar portion and extending in a second plane perpendicular to the first plane, the second terminal member comprising a second planar portion extending in a third plane parallel to the first plane and a second tab (e.g., 406b) coupled to the second planar portion and extending in a fourth plane parallel to the second plane; and first and second cables (e.g., 104a, 104b), each of the first and second cables comprising an insulation and a wire (e.g., 408a, 408b) disposed in the insulation and having an end extending beyond the insulation, the end of the wires of the first and second cables welded to the first and second tabs, respectively.

19. The cable assembly of aspect 18, wherein: each of the first and second planar portions comprises first and second edges (e.g., 416A, 416B) opposite to each other, and first and second broadsides (e.g., 418A, 418B) opposite to each other and both joining the first and second edges; the first tab (e.g., 406a) is coupled to the first edge (e.g., 416A) of the first planar portion of the first terminal member; and the second tab (e.g., 406b) is coupled to the second edge (e.g., 416B) of the second planar portion of the second terminal member.

20. The cable assembly of aspect 19, wherein both the first tab and the second tab extend away from either the first broadsides or the second broadsides of the first and second planar portions.

21. The cable assembly of aspect 18, wherein the end of the wires of the first and second cables are welded to the first and second tabs at their sides; and front surfaces of the wires of the first and second cables are welded to the first planar portion.

22. The cable assembly of aspect 18, wherein the terminal is a first terminal; and the cable assembly comprises: a second terminal comprising third and fourth terminal members (e.g., 105c, 105d), the third terminal member comprising a third planar portion extending in a fifth plane parallel to the first plane and a third tab coupled to the third planar portion and extending in a sixth plane parallel to the second plane, the fourth terminal member comprising a fourth planar portion extending in a seventh plane parallel to the first plane and a fourth tab coupled to the fourth planar portion and extending in an eighth plane parallel to the second plane; and third and fourth cables, each of the third and fourth cables comprising an insulation and a wire disposed in the insulation and having an end extending beyond the insulation, the end of the wires of the third and fourth cables welded to the third and fourth tabs, respectively.

23. The cable assembly of aspect 22, wherein each of the third and fourth planar portions comprises first and second edges opposite to each other, and first and second broadsides opposite to each other and both joining the first and second edges; the third tab is coupled to the first edge of the third planar portion of the third terminal member; and the fourth tab is coupled to the second edge of the fourth planar portion of the fourth terminal member.

24. The cable assembly of aspect 23, wherein both the third tab and the fourth tab extend away from either the first broadsides or the second broadsides of the third and fourth planar portions.

25. The cable assembly of aspect 22, wherein the end of the wires of the third and fourth cables are welded to the third and fourth tabs at their sides; and front surfaces of the wires of the third and fourth cables are welded to the third planar portion.

26. The cable assembly of aspect 22, comprising: a housing comprising first and second slots configured to receive complementary terminals for mating with the first and second terminals, respectively.

27. The cable assembly of aspect 26, comprising: first and second terminal position assurance (TPA) devices (e.g., 106) disposed on the housing and configured to restrain movements of the first and second terminals, respectively.

28. The cable assembly of aspect 27, wherein each of the first and second TPA devices comprises a body (e.g., 106A) configured for engaging a respective terminal of the first and second terminals, and a latch (e.g., 106B) extending from the body and configured for engaging the housing.

29. An electrical connector comprising: a housing (e.g., 101, 102, 112); first and second terminals (e.g., 105) held by the housing, each of the first and second terminals comprising two terminal members (e.g., 105a and 105b, 105c and 105d), each of the two terminal members comprising a planar portion (e.g., 404) and a tab (e.g., 406) coupled to the planar portion; first and second cables (e.g., 104a and 104b) attached to respective terminal members of the two terminal members of the first terminal; and third and fourth cables (e.g., 104c and 104d) attached to respective terminal members of the two terminal members of the second terminal, wherein each of the first and second terminals has a current carrying capacity up to 140 A.

30. The electrical connector of aspect 29, wherein the housing comprises a first portion (e.g., 101) having one or more posts (e.g., 110a, 110b) protruding in a mating direction, and a second portion (e.g., 102) attached to one or more sides of the first portion.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present disclosure. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector, comprising:
a housing comprising a first portion having a mating end having first and second slots, and a second portion attached to one or more sides of the first portion;
first and second terminals, each of the first and second terminals comprising a plurality of terminal members, each of the plurality of terminal members comprising a mating end disposed in a respective slot of the first and second slots of the first portion of the housing and a tail at least partially disposed in the second portion of the housing; and
a plurality of cables attached to respective terminal members of the first and second terminals and extending out of the housing through a side of the second portion of the housing.

2. The electrical connector of claim 1, further comprising:
first and second terminal position assurance (TPA) devices disposed on the first portion of the housing, the first and second TPA devices configured to restrain movements of the plurality of terminal members in the first and second slots, respectively.

3. The electrical connector of claim 2, wherein:
each of the first and second TPA devices comprises a body configured for engaging the plurality of terminal members of a respective terminal of the first and second terminals, and a latch extending from the body and configured for engaging the housing.

4. The electrical connector of claim 1, wherein:
each of the first and second terminals comprises first and second terminal members, each of the first and second terminal members comprising a planar portion extending from the mating end to the tail, and a tab extending from the tail of the planar portion and attached to a respective cable of the plurality of cables.

5. The electrical connector of claim 1, wherein:
the first portion of the housing comprises a front plate, and one or more posts protruding from the front plate toward the mating end.

6. The electrical connector of claim 1, wherein:
the housing comprises a third portion protruding from the first portion and configured to receive a connector position assurance (CPA) device.

7. The electrical connector of claim 1, wherein:
the first portion of the housing comprises a plurality of apertures disposed between the first and second slots.

8. A cable assembly comprising:
a terminal comprising first and second terminal members, the first terminal member comprising a first planar portion extending in a first plane and a first tab coupled to the first planar portion and extending in a second plane perpendicular to the first plane, the second terminal member comprising a second planar portion extending in a third plane parallel to the first plane and a second tab coupled to the second planar portion and extending in a fourth plane parallel to the second plane; and
first and second cables, each of the first and second cables comprising an insulation and a wire disposed in the insulation and having an end extending beyond the insulation, the end of the wires of the first and second cables welded to the first and second tabs, respectively.

9. The cable assembly of claim 8, wherein:
each of the first and second planar portions comprises first and second edges opposite to each other, and first and second broadsides opposite to each other and both joining the first and second edges;
the first tab is coupled to the first edge of the first planar portion of the first terminal member; and
the second tab is coupled to the second edge of the second planar portion of the second terminal member.

10. The cable assembly of claim 9, wherein:
both the first tab and the second tab extend away from either the first broadsides or the second broadsides of the first and second planar portions.

11. The cable assembly of claim 8, wherein:
the end of the wires of the first and second cables are welded to the first and second tabs at their sides; and
front surfaces of the wires of the first and second cables are welded to the first planar portion.

12. The cable assembly of claim 8, wherein:
the terminal is a first terminal; and
the cable assembly comprises:
a second terminal comprising third and fourth terminal members, the third terminal member comprising a third planar portion extending in a fifth plane parallel to the first plane and a third tab coupled to the third planar portion and extending in a sixth plane parallel to the second plane, the fourth terminal member comprising a fourth planar portion extending in a seventh plane parallel to the first plane and a fourth tab coupled to the fourth planar portion and extending in an eighth plane parallel to the second plane; and
third and fourth cables, each of the third and fourth cables comprising an insulation and a wire disposed in the insulation and having an end extending beyond the insulation, the end of the wires of the third and fourth cables welded to the third and fourth tabs, respectively.

13. The cable assembly of claim 12, wherein:
each of the third and fourth planar portions comprises first and second edges opposite to each other, and first and second broadsides opposite to each other and both joining the first and second edges;
the third tab is coupled to the first edge of the third planar portion of the third terminal member; and
the fourth tab is coupled to the second edge of the fourth planar portion of the fourth terminal member.

14. The cable assembly of claim 13, wherein:
both the third tab and the fourth tab extend away from either the first broadsides or the second broadsides of the third and fourth planar portions.

15. The cable assembly of claim 12, wherein:
the end of the wires of the third and fourth cables are welded to the third and fourth tabs at their sides; and
front surfaces of the wires of the third and fourth cables are welded to the third planar portion.

16. The cable assembly of claim 12, comprising:
a housing comprising first and second slots configured to receive complementary terminals for mating with the first and second terminals, respectively.

17. The cable assembly of claim 16, comprising:
first and second terminal position assurance (TPA) devices disposed on the housing and configured to restrain movements of the first and second terminals, respectively.

18. The cable assembly of claim 17, wherein:
each of the first and second TPA devices comprises a body configured for engaging a respective terminal of the first and second terminals, and a latch extending from the body and configured for engaging the housing.

19. An electrical connector comprising:
a housing;
first and second terminals held by the housing, each of the first and second terminals comprising two terminal members, each of the two terminal members comprising a planar portion and a tab coupled to the planar portion;
first and second cables attached to respective terminal members of the two terminal members of the first terminal; and
third and fourth cables attached to respective terminal members of the two terminal members of the second terminal,
wherein each of the first and second terminals has a current carrying capacity up to 140 A.

20. The electrical connector of claim 19, wherein:
the housing comprises a first portion having one or more posts protruding in a mating direction, and a second portion attached to one or more sides of the first portion.
